(19) United States
(12) Patent Application Publication
(10) Pub. No.: US 2004/0222607 A1
(43) Pub. Date: Nov. 11, 2004

(54) Strollers and methods of operating strollers

(76) Inventor: Peter J. Myers, Wheaton, IL (US)

Correspondence Address: GROSSMAN & FLIGHT, LLC, 20 N. WACKER DRIVE, SUITE 4220, CHICAGO, IL, 60606, US

(21) Appl. No.: 10/429,658

(22) Filed: May 5, 2003

(51) Int. Cl. B62B 9/20

(52) U.S. Cl. 280/47.38

(57) ABSTRACT

Strollers and methods of operating strollers are disclosed. An example stroller includes a wheeled frame, a first handle, and a second handle pivotably coupled to the first handle.

### FIELD OF THE DISCLOSURE

This disclosure relates generally to strollers, and, more particularly, to strollers and methods of operating strollers.

### BACKGROUND

Strollers are commonly used by parents to transport infants and small children. Typically, strollers include a frame including a lower, wheeled frame and a handle. The handle is frequently pivoted to the wheeled frame by a releasable lock arrangement. Releasing the lock permits the handle to pivot relative to the lower frame to thereby collapse the stroller for storage and/or transport.

Many lock mechanisms and actuators for operating the same are known. Frequently, the actuator is mounted to the handle. These actuators are often coupled to the lock mechanism(s) by one or more cables running interior to the handle. Manipulation of the actuator pulls the cable(s) to thereby move and release the lock mechanism(s) to permit folding of the stroller.

Manipulation of the prior art actuators to release the lock mechanisms involve linear movement of a depressible button, linear pulling of one or more tabs, and/or movement of a lever. Sometimes, a lock out mechanism with a separate actuating button, tab, or lever is employed to make sure the lock mechanism was not inadvertently released by accidental movement of the primary actuator. In such circumstances, the lock out actuator must be activated before the primary actuator can be manipulated to release the lock mechanism.

Prior art strollers typically include a U-shaped handle. In some instances, the lower portion of the U is longitudinally movable relative to the arms of the U to permit the height of the handle grip to be adjusted to users of different heights.

Some prior art handle grips include a leg positioned in a bi-secting plane of the stroller to facilitate one-handed gripping and steering of the stroller.

### BRIEF DESCRIPTION OF THE DRAWINGS

FIG. 1 is a perspective view of an example stroller having a primary handle and a secondary handle.

FIG. 2 is a view similar to FIG. 1, but showing the secondary handle in a different position.

FIG. 3 is a top view of the secondary handle, the actuator and a portion of the primary handle of the example stroller of FIGS. 1-2.

FIG. 4 is a cross-sectional view taken along lines 4-4 of FIG. 3.

FIG. 5 is a perspective, exploded view of an actuator for folding the stroller of FIG. 1.

FIG. 6 is a side, exploded view of the actuator of FIG. 5.

FIG. 7 is a side view showing an example range of motion of the secondary handle of the stroller of FIGS. 1-6.

FIG. 8 is a cross-sectional view taken along lines 8-8 of FIG. 3.

FIG. 9 is a view similar to FIG. 3, but showing the lock of the secondary handle released.

FIG. 10 is a side view of the stroller of FIG. 1.

FIG. 11 is view similar to FIG. 10, but showing the stroller in a partially folded position.

FIG. 12 is a partial cross-sectional view of the stroller of FIGS. 1-11 showing the lock mechanism in the locked position.

FIG. 13 is a view similar to FIG. 12, but showing the lock mechanism in the released position with the stroller in the position of FIG. 11.

FIG. 14 is a partial cross-sectional view of the actuator of FIG. 5.

FIG. 15 is a side view of the actuator of FIG. 14, showing the depressible element in the released position.

FIG. 16 is a top, partial cross-sectional view of the actuator and handle of FIGS. 1-15.

FIG. 17 is a front, cut-away view of the actuator of FIG. 16.

### DETAILED DESCRIPTION

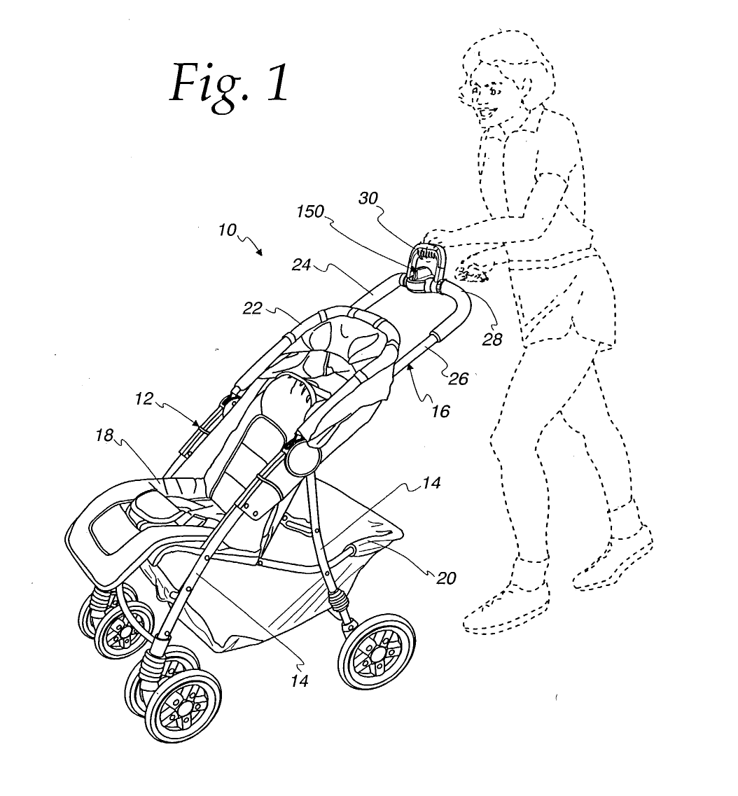

FIG. 1 is a perspective view of an example stroller 10. The stroller 10 of FIG. 1 includes a frame 12 comprising a lower, wheeled frame 14 and a primary handle 16. In the illustrated example, the wheeled frame 14 includes six wheels, two on each of the front legs and one on each of the rear legs. However, persons of ordinary skill in the art will appreciate that other numbers of wheels could alternatively be employed. Similarly, although the illustrated frame 12 includes four legs, persons of ordinary skill in the art will readily appreciate that other numbers of legs (e.g., three) could alternatively be employed. For example, three legs might be preferred if the stroller 10 is intended as a jogging stroller.

In the illustrated example, the frame 12 supports a seat for carrying a child, a seat belt to secure the child in the seat, and a basket 20 for carrying a variety of items. The illustrated stroller 10 also includes a conventional, pivotable canopy 22. Although not shown in the illustrated example, other conventional stroller features might also be included. For example, a brake to substantially secure the stroller 10 against movement might be included, a tray for food, drinks and/or toys might be included in front of the seat for use by a seated child, and/or a parent tray might be mounted to the primary handle 16 in a position to support drinks, food, and/or other objects within easy reach of a standing adult pushing the stroller.

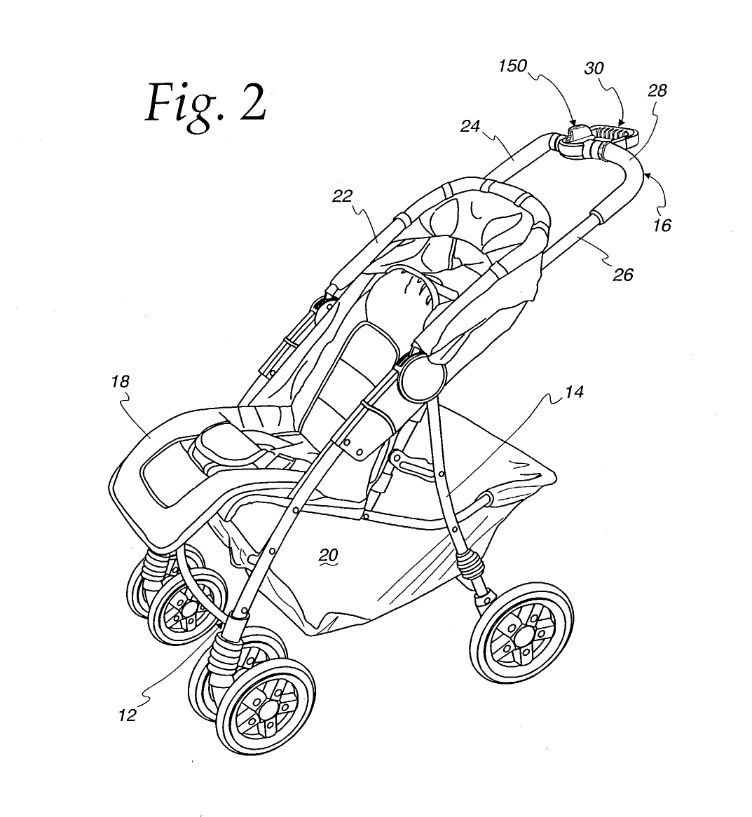

The illustrated primary handle 16 is generally U-shaped, although persons of ordinary skill in the art will readily appreciate that other shapes and configurations of the primary handle 16 would likewise be appropriate. The example primary handle of FIGS. 1-2 includes first and second arms 24, 26 extending rearwardly from the wheeled frame 12. It also includes a primary grip 28 joining the first and second arms 24, 26. Although other shaped grips and other orientations are likewise appropriate, in the illustrated example, the primary grip 28 is a generally cylindrical bar having a gripping surface positioned in a generally horizontal plane. The grip 28 is preferably dimensioned such that a standing adult pushing the stroller 10 may grip the bar 28 with two hands.

For the purpose of facilitating one hand steering, the stroller 10 is further provided with a secondary handle 30. Like the primary handle 16, in the illustrated example the second handle 30 is also generally U-shaped. Thus, the second handle 30 includes first and second arms 32, 34 and a grip 36 joining the first and second arms 32, 34. The grip 36 of the second handle 30 is much smaller than the grip 28 of the primary handle 16. In particular, whereas the primary grip 28 is dimensioned to be gripped with two hands, the secondary grip 28 is dimensioned to be gripped with one hand. As explained further below, in the illustrated example, the grip 28 of the primary handle 16 has a first gripping section on a first side of the second handle 30, and a second gripping section on a second side of the second handle 30. As a result, the gripping section of the second handle 30 is located between the gripping sections of the grip 28 of the primary handle 16.

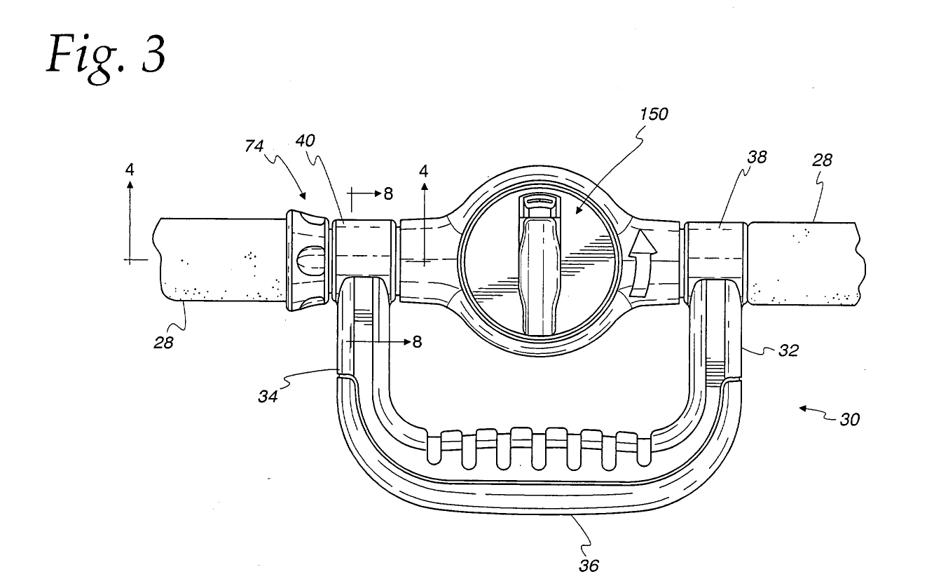

The second handle 30 is pivotably coupled to the primary handle 16. In particular, as shown in FIG. 3, the second handle 30 includes a first end 38 which is pivotably coupled to the grip 28 of the first handle 16 and a second end 40 which is also pivotably coupled to the grip 28 of the first handle 16. The first and second ends 38, 40 of the second handle 30 are coupled to the grip 28 of the primary handle 16 between the first and second gripping sections of the primary handle 16. Preferably, the first and second ends 38, 40 of the second handle 30 are spaced on opposite sides of a central plane which bi-sects the stroller 10 into substantially symmetrical right and left halves. Preferably, the centers of the primary and secondary handles 16, 30 are aligned on the bi-secting plane (i.e., on the central axis of the stroller 10). In the illustrated example, the first and second ends 32, 34 of the second handle 30 are positioned at equal, but opposite, distances from the central, bi-secting plane such that half of the grip 36 of the second handle 30 is located on each side of the bi-secting plane. As a result, when a person pushing the stroller 10 grips the second handle 30 (see FIG. 1) with one hand, they can easily steer the stroller 10 in a desired direction by applying force to the second handle 30 with that single gripping hand.

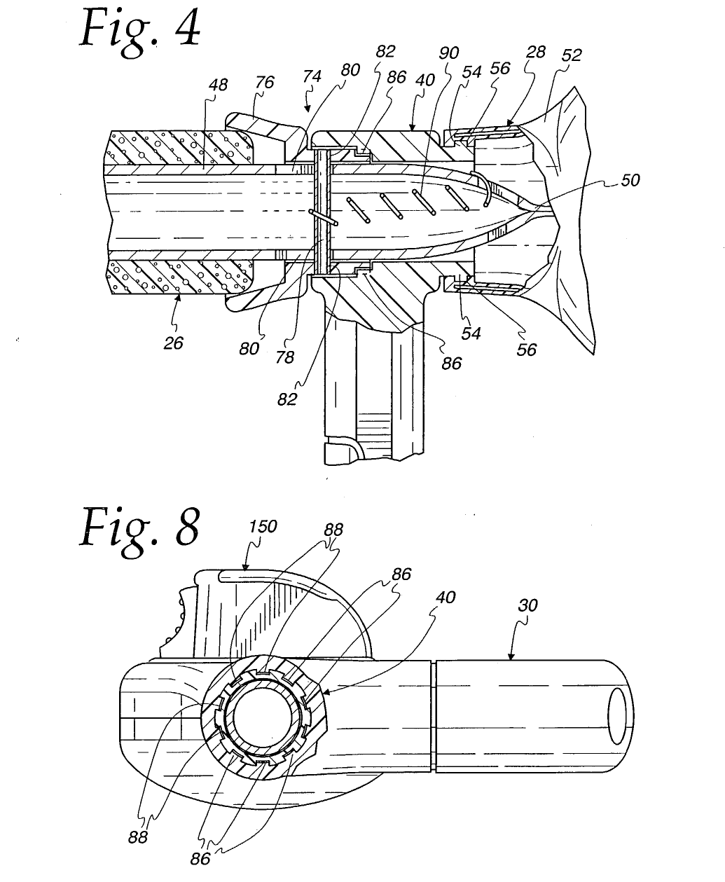

The pivoting connection between the illustrated first and second handles 16, 30 is shown in greater detail in FIG. 4. Because the same pivoting connection is used with respect to both ends 38, 40 of the second handle 30, only the pivoting connection joining the second end 40 of the second handle 30 to the first handle 16 will be described herein. Persons of ordinary skill in the art will appreciate that the pivoting connection of the first end 38 of the second handle 30 to the first handle is symmetrically identical to the connection shown in FIG. 4.

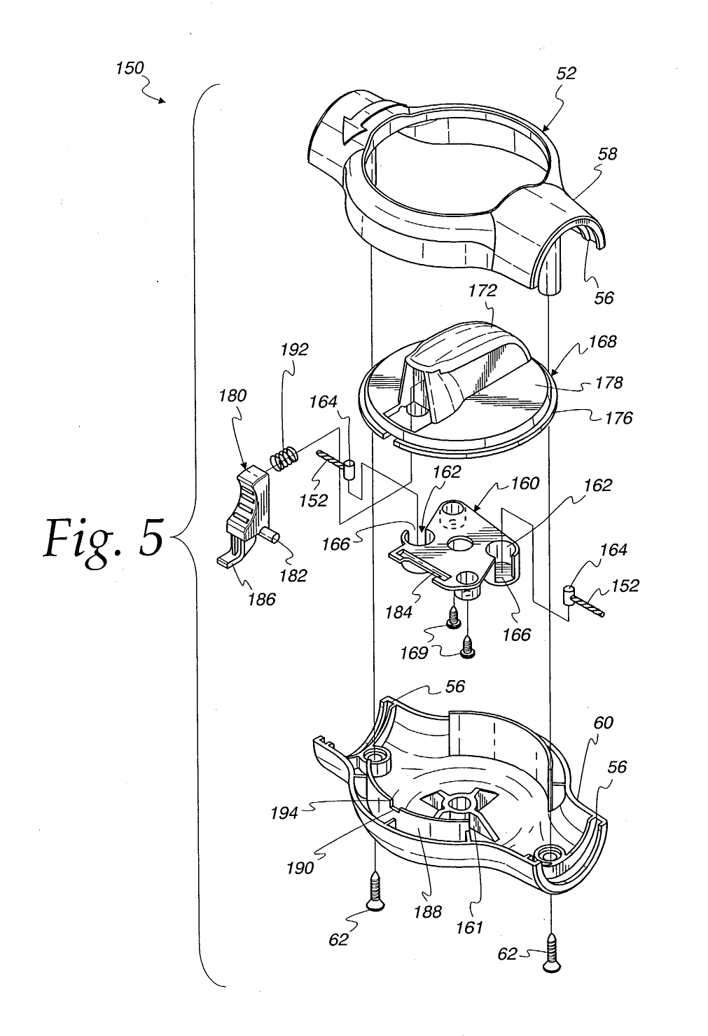

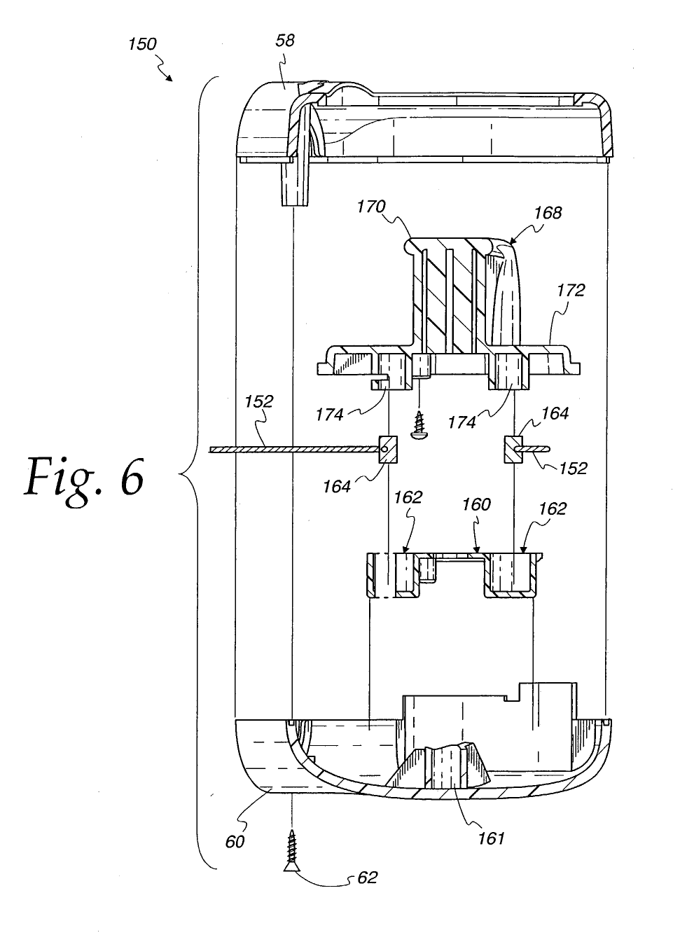

As shown in FIG. 4, the grip 28 of the primary handle 16 includes a metal tube 48. The illustrated metal tube 48 is pinched together to form a flattened section 50 in the middle of the primary handle 16 between the first and second ends 38, 40 of the second handle 30. In the illustrated example, a primary handle housing 52 is mounted on the metal tube 48 in the vicinity of the pinched section of the tube 48 between the first and second ends 38, 40 of the second handle 30. As also shown in FIG. 4, the second end 40 of the second handle 30 includes an annular flange 54. The grip 28 of the primary handle 16, on the other hand, defines a circular recess 56 which is dimensioned to receive the annular flange 54. When the flange 54 is disposed in the recess 56, the flange 54, and, thus, the end 40 of the second handle 30 may be rotated relative to the primary handle housing 52. Preferably, the primary handle housing 52 includes two sections 58, 60 that are secured together by fasteners 62 such as threaded screws (see FIGS. 5 and 6). As a result, the annular flange 54 may be easily captured within the recess 56 and between the two sections 58, 60 of the primary handle housing 52 during manufacture of the stroller 10. Once so captured, the first end 40 may be rotated relative to the primary handle housing 52, but otherwise remains connected to the same.

Because of the pivoting connection between the ends 38, 40 of the second handle 30 and the primary handle 16, the second handle 30 is rotatable relative to the primary handle 16 such that the gripping surface 36 of the second handle 30 may be positioned in a range of positions relative to the gripping surface 28 of the primary handle 16. As shown in FIG. 7, the illustrated second handle 30 can be rotated 360° around the primary handle 16. Thus, the secondary handle 30 may extend rearwardly from the primary handle 16, forwardly of the primary handle 16, above the primary handle 16, and/or below the primary handle 16. Since, in the illustrated example, the range of positions of the gripping surface 36 are located on an arc around the primary handle 16, the second gripping surface 36 may be located above the primary gripping surfaces 28, below the primary gripping surfaces 28, in the same plane as the primary gripping surfaces 28, behind the primary gripping surfaces 28 and/or forward of the primary gripping surfaces 28.

In order to releasably secure the second handle 30 against movement relative to the primary handle 16, the stroller 10 is further provided with a lock 74. As most easily seen in FIG. 4, the lock 74 includes a lock member 76. The lock member 76 is an annular structure that is mounted to the bar 48 of the primary handle 16 for longitudinal movement along the same. To prevent the lock member 76 from rotating relative to the bar 48, a pin 78 extends transversely to the longitudinal axis of the bar 48 through opposed apertures 80 formed in the bar 48 and into bores 82 formed in the lock member 76. In the illustrated example, each of the bores 82 is dimensioned to snugly receive one of the opposed ends of the pin 78 such that the lock member 76 may not move relative to the pin 78. The apertures 80, on the other hand, extend a distance along the longitudinal axis of the bar 48 such that the pin 78 may slide along the longitudinal axis of the bar 48. As a result, the lock member 76 is longitudinally movable relative to the bar 48, but is not rotatable relative to the bar 48.

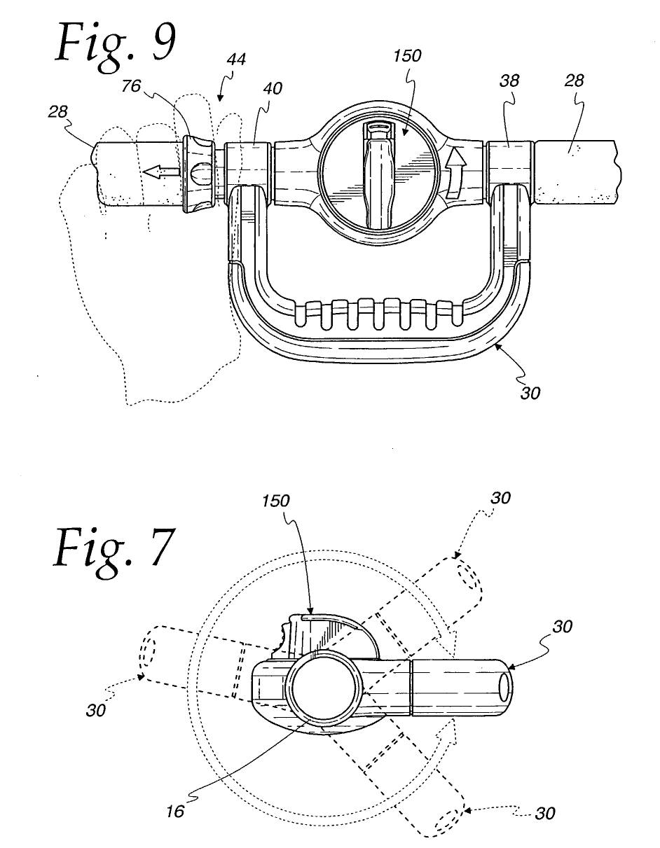

To secure the secondary handle 30 against rotation, the first end 40 of the secondary handle 30 includes a series of inwardly directed, radial teeth 86 (see FIG. 8). The radial teeth 86 of the illustrated example are evenly spaced from one another such that they define a series of radial apertures. An end of the lock member 76, on the other hand, defines a series of apertures 88 that are dimensioned and positioned to mate with the teeth 86 as shown in FIG. 8. When the teeth 86 are located in the apertures 88 of the lock member 76, the secondary handle 30 is in locking engagement with the lock member 76. Since, as explained above, the lock member 76 is secured against rotation relative to the bar 48 of the primary handle 16, the locking engagement between the teeth 86 and the lock member 76 likewise secures the second handle 30 against rotation relative to the primary handle 16. Thus, to free the second handle 30 for rotation relative to the primary handle 16, the lock member 76 must be moved along the longitudinal axis of the bar 48 away from the primary handle housing 52 as shown in FIG. 9 a distance sufficient to disengage the teeth 86 of the second end 40 and the lock member 76. In other words, the lock member 76 is longitudinally movable between a first position (illustratively, the position of FIG. 4) wherein the lock member 76 engages the second handle 30 to prevent rotation of the second handle 30, and a second position (illustratively, the position of FIG. 9) wherein the lock member separates from the second handle 30 to permit rotation of the second handle 30.

To ensure the locking engagement between the lock member 76 and the first end 40 is not accidentally released, the lock mechanism is further provided with a spring 90. As shown in FIG. 4, the illustrated spring 90 is a coil spring having an end secured to the pin 78 and an end secured to the bar 48. The coil spring 90 is preferably loaded even when the lock member 76 is in the locking position shown in FIG. 4 to bias the lock member toward the locked position.

Although the illustrated stroller 10 includes only one lock mechanism 74, persons of ordinary skill in the art will readily appreciate that other numbers and/or types of lock mechanism(s) may alternatively be employed. For example, a second lock mechanism such as mechanism 74 may be provided at the second end 38 of the second handle 30.

In operation, the position of the illustrated second handle 30 may be easily adjusted from a first position to a second position by disengaging the lock securing the second handle 30 relative to the primary handle 16. In the illustrated example, the lock is disengaged by moving the lock element 76 along the longitudinal axis of the grip 28 of the primary handle 16 in a direction away from the primary handle housing 52. After the lock is disengaged, the second handle 30 may be moved relative to the primary handle 30 to the desired second position. For example, in the illustrated stroller 10, the second handle 30 may be moved relative to the first handle 16 by rotating the second handle 30 relative to the first handle 16 (e.g., rotating the second handle 30 about a central axis of the primary handle 16). Once the second handle 30 is in a desired position, the second handle 30 may be secured in that position by re-engaging the lock. In the illustrated example, re-engaging the lock can be accomplished by releasing the lock member 76 to permit it to move under the influence of the spring 90 back into engagement with the end 40 of the second handle 30.

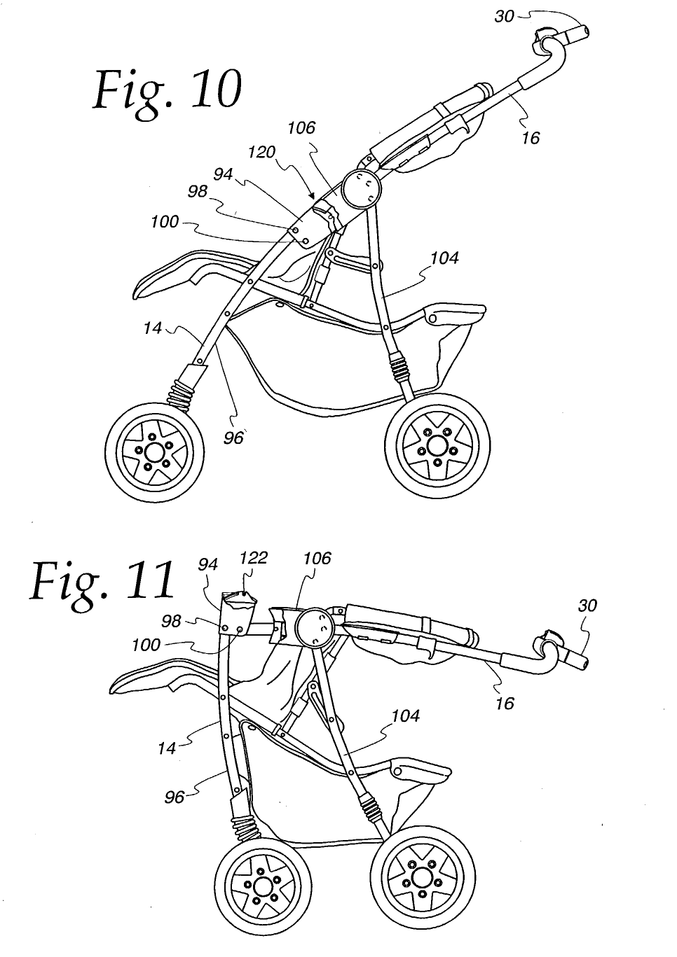

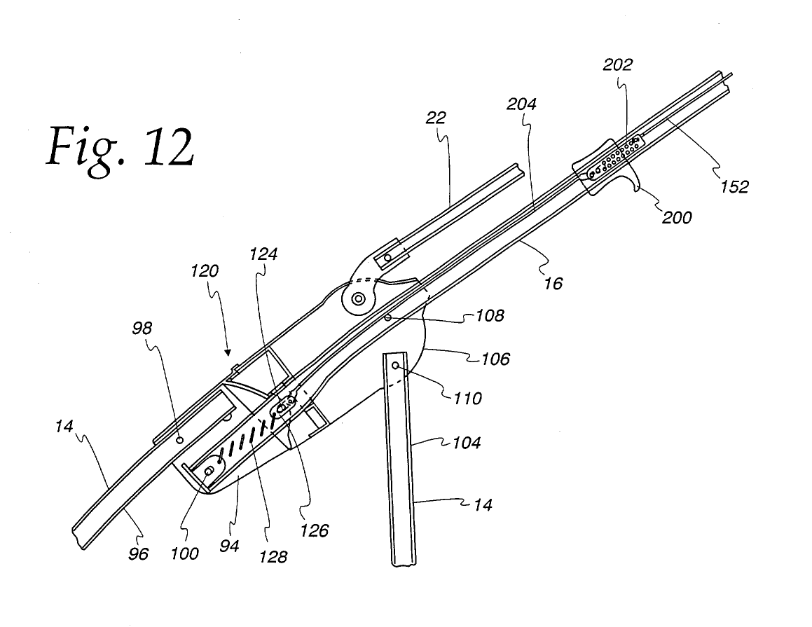

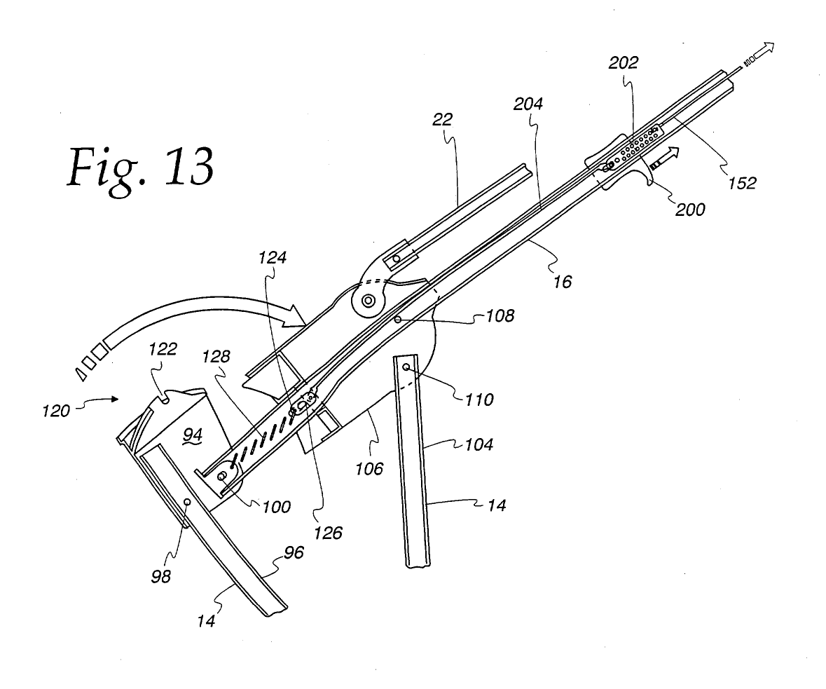

In the illustrated example, the primary handle 30 of the stroller 10 is pivotably connected to the wheeled frame 14 to facilitate folding of the same in a conventional manner. For example, as shown in FIGS. 10-13, the wheeled frame 14 may include a pair of identical lower joint housings 94. As most easily seen in FIGS. 12 and 13, each of the front legs 96 of the wheeled frame 14 includes is fastened to a respective one of the lower joint housings 84 via a conventional fastener 98 such as a rivet to preclude relative movement between the front legs 96 of the wheeled frame 14 and respective ones of the lower joint housings 84.

In the illustrated example, the lower end of each of the arms 24, 26 of the primary handle 16 is pivotably coupled to a respective one of the lower joint housings 94. For example, a bore in each of the lower ends of the arms 24, 26 may be respectively penetrated by, and rotatable about, a pin 100 that is fixed to respective ones of the lower joint housings 94. As a result, the primary handle 16 is pivotable relative to the lower joint housings 94. Since the lower joint housings 94 are fixed to the front legs 96 of the wheeled frame 14, the primary handle 16 is also pivotable relative to the front legs 26 of the wheeled frame 14 as shown in FIGS. 11 and 13.

To pivotably couple the primary handle 16 to the rear legs 104 of the wheeled frame 14, the illustrated stroller 10 is further provided with a pair of upper joint housings 106. As most easily seen in FIGS. 12 and 13, each of the arms 24, 26 of the primary handle 16 is fixed to a respective one of the upper joint housings 106 by a conventional fastener 108 such a rivet to preclude relative movement between the primary handle 16 and the upper joint housings 106. The rear legs 104 of the wheeled frame 14, on the other hand, are coupled to respective ones of the upper joint housings 106 via pins 110 and bores as explained above. As a result, the rear legs 104 are pivotable relative to the upper joint housings 106. Since the upper joint housings 106 are fixed to the primary handle 16, the rear legs 104 of the wheeled frame 14 are also pivotable relative to the primary handle 16 as shown in FIGS. 11 and 13.

To releasably prevent folding of the frame 12, the illustrated stroller 10 is further provided with a lock 120. As most easily seen in FIGS. 12 and 13, the illustrated lock 120 includes a pair of apertures 122 formed in respective ones of the lower joint housings 94 and a mating pair of pins 124 carried by respective ones of the arms 24, 26 of the primary handle 16. When the pins 124 are disposed within their corresponding apertures 122, the upper joint housings 106 are precluded from pivoting relative to the lower joint housings 94. When the pins 124 are withdrawn from their corresponding apertures 122, the upper joint housings 106, and, thus, the primary handle 16 is free to pivot relative to the lower joint housings 94.

More specifically, each of the arms 24, 26 defines a pair of oppositely disposed apertures near its lower end. Each of the apertures is dimensioned to receive a corresponding end of a pin 124. Each of the pins 124 is mounted within a pair of the apertures such that each of the pins 124 extends transversely to the longitudinal axis of the handle arm 24, 26 with which it is associated. The apertures extend along the longitudinal axis of their respective arms 24, 26 to thereby permit the corresponding pins 124 to slide along the longitudinal axis of the corresponding arms 24, 26.

Each of the pins 124 penetrates a yoke 126 disposed within the corresponding arms 24, 26 of the primary handle 16. Each of the yokes 126 is coupled to an end of a spring 128. The opposite end of the spring 128 is fixed to one of the pins 100 within the corresponding arms 24, 26 of the primary handle such that the springs 128 bias their corresponding yokes 126, and, thus, the pins 124 toward the ends of their respective arms 24, 26. The movement of the yokes 126 and the pins 124 toward the ends of the arms 24, 26 is limited by the apertures receiving the ends of the pins 124. When the upper and lower joint housings 106, 94 are aligned as shown in FIGS. 10 and 12, the springs 128 pull their corresponding pins 124 into engagement with the apertures 122 to prevent folding of the frame 12 as explained above.

To remove the pins 124 from their apertures 122 to unlock the locks 120 and permit folding of the frame 12, the illustrated stroller 10 is further provided with a release mechanism. In the illustrated example, the release mechanism includes an actuator 150 which is operatively coupled to the locks 120 such that rotating the actuator 150 releases the locks 120 to permit folding of the frame 12. In the illustrated stroller 10, the actuator 150 is disposed in the center of the grip 28 of the primary handle 16 for easy actuation by a standing adult and the actuator 150 is operatively coupled to the locks 120 by cables 152. In particular, as shown in FIGS. 5, 6, 9 and 14-17, the actuator 150 is mounted within the primary handle housing 52 and the cables 152 are disposed within the primary handle 16. As explained in detail below, rotating the actuator 150 pulls the cables 152 upward to remove the pins 124 from the apertures 122 to unlock the locks 120.

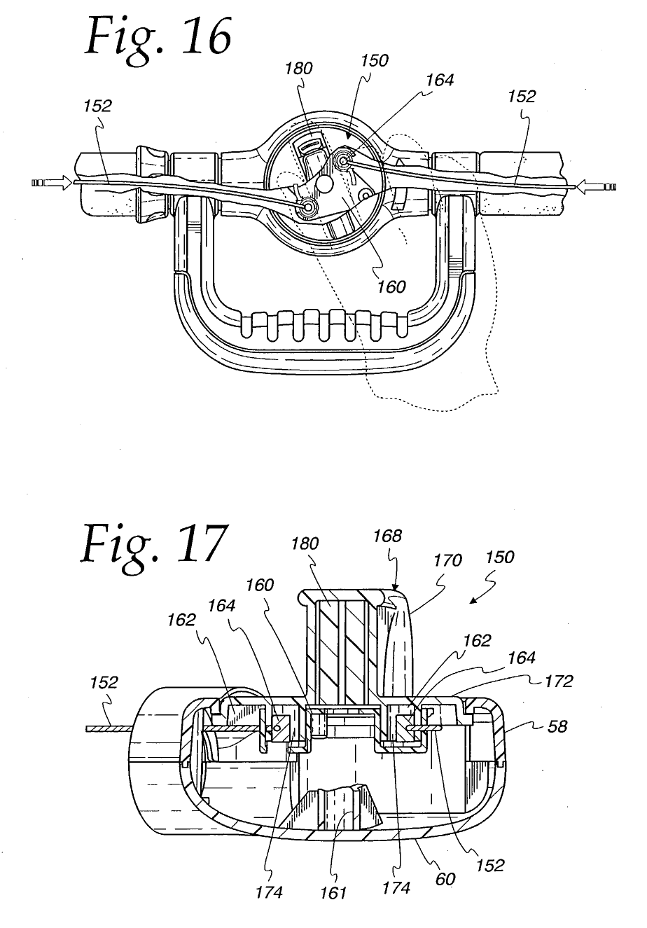

The example actuator 150 of the illustrated stroller 10 is shown in detail in FIGS. 5, 6, 9 and 14-17. As shown in those figures, the illustrated actuator 150 includes a rotatable element 160 which is mounted on a pedestal 161 within the primary handle housing 52 for rotation about a vertical axis. The rotatable element 160 defines oppositely disposed wells 162. Each of the wells 162 is dimensioned to receive a lug 164 which is coupled to an end of a respective one of the cables 152. In the illustrated example, the wells 162 and the lugs 164 are cylindrical, and the wells 162 are in communication with slots 166 (see FIG. 5) to permit the cables 152 to enter the wells 164 from the side. As most easily seen in FIG. 16, rotating the rotatable element 160 in a generally horizontal plane pulls the cables 152 in opposite directions against the force of the springs 128 to thereby unlock the locks 120.

To facilitate rotation of the rotatable element 160, the release mechanism is further provided with a housing 168 coupled to the rotatable element 160. For example, the housing 168 may be coupled to the rotatable element by conventional fasteners 169 such as screws as shown in FIG. 5. As shown in FIGS. 5, 6, 9 and 14, the illustrated housing 168 includes a circular base 170 and a projection 172 extending upwardly from the base 170. The circular base 170 is rotatably received within a circular opening formed in the top of the primary handle housing 52. In particular, as shown in FIG. 5, the base 170 includes an outwardly extending rim 176 that prevents the housing 168 from passing through the opening in the upper section 58 of the primary handle housing 52, while permitting rotation of the base 170 within a generally horizontal plane. Thus, the rotatable element 160 is captured between: (a) the upper section 58 of the primary handle housing 52 and the housing 168, and (b) the pedestal 161 of the lower section 60 of the primary handle housing 52.

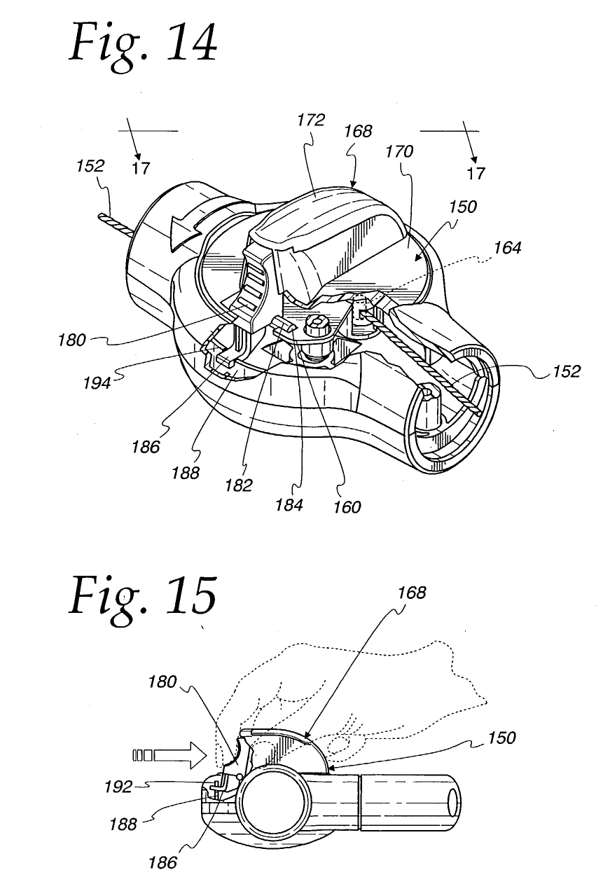

For the purpose of preventing inadvertent rotation of the rotatable element 160, the illustrated actuator 150 is further provided with a depressible element 180. The illustrated depressible element 180 is pivotably mounted to the housing 168 for pivoting about a substantially horizontal axis. More specifically, the depressible element 180 includes a pair of outwardly extending lugs 182 (see FIG. 5) that are seated in a slot 184 defined in the rotatable element 160 (see FIG. 14). When the lugs 182 are seated in the slot 184 and the housing 168 is fastened to the rotatable element 160, the depressible element 180 is positioned adjacent and/or in an opening defined in the projection 170 of the housing 168.

As shown in FIGS. 5 and 14 and 15, the depressible element 180 includes a downwardly extending projection 186 which functions to limit the rotatability of the rotating element 160. More specifically, as most easily seen in FIG. 5, the lower section 60 of the primary handle housing 52 includes a wall 188. The wall defines a slot 190. When the actuator 150 is positioned in its locked state (see, for example, FIG. 14), the projection 186 of the depressible element 180 rests in the slot 190 to thereby prevent rotation of the depressible element 180 and, thus, to prevent rotation of the rotatable element 160 carrying the depressible element 180. When, on the other hand, the depressible element 180 is depressed (see, for example, FIG. 15 where the depressible element 160 is partially retracted into the projection 172 of the housing 168), the projection 186 of the depressible element 180 is pivoted out of the slot 190 such that the depressible element 180 and, thus, the rotatable element 160 can be rotated. In other words, the depressible element 180 is movable between a first position wherein the depressible element 180 prevents rotation of the rotatable element 180 and a second position wherein the depressible element permits rotation of the rotatable element 180. Persons of ordinary skill in the art will appreciate that, although the illustrated depressible element 180 is pivotable between the first and second positions, it could alternatively be linearly movable (e.g., movable along a straight line) between the first and second positions.

In order to ensure the projection 186 of the depressible element 180 engages in the slot 190 when the rotatable element 160 is in its rest position (illustratively, the position of FIG. 14), the actuator is further provided with a spring 192. As shown in FIG. 5, the spring 192 is positioned between the back of the depressible element 180 and a support within the housing 168. Thus, when a user wishes to operate the actuator 150 to release the locks 122, the user must depress the depressible element 180 against the force of the spring 192. When the user releases, the depressible element 180, the depressible element 180 will attempt to pivot forward under the influence of the spring force.

To ensure the rotatable element 160 is rotated in the correct direction to release the lock 120, the illustrated actuator 150 is further provided with a stop 192. As shown in FIGS. 5 and 14, the stop 192 of the illustrated actuator 150 is a part of the wall 188. In particular, the part of the wall 188 to the left of the slot 190 in FIG. 5 is higher than the part of the wall 188 to the right of the slot 190 in that figure such that, when the depressible element 180 is pivoted out of the slot 190, the projection 186 of the depressible element 180 can be rotated in a first direction over the lower part of the wall 188, but is blocked from rotating in the direction opposite the first direction by the higher part 192 of the wall 188.

In operation, a user wishing to use the actuator 150 to unlock the locks 120 to permit the handle 16 to be folded relative to the wheeled frame 14 would first depress the depressible element 180 in a first direction to release the rotatable element 160 (see FIG. 15). The user would then rotate the rotatable element 160 about an axis that is generally perpendicular to the first direction to unlock the frame 12 of the stroller 10. The handle 16 can then be pivoted downward to fold the stroller 10. As shown in FIG. 15, because of the location of the depressible element 180, the depressible element 180 may be depressed with the same hand that is used to rotate the rotatable element 160. In other words, the depressible element 180 and the rotatable element 160 are positioned to be actuated with the same hand.

To permit folding without using the actuator 150, the release mechanism is further provided with actuating tabs 200 (see FIGS. 12 and 13). Each of the cables 152 is coupled to a plate 202 which is in turn coupled to a lower cable 204. The lower cables 204 are coupled to respective ones of the yokes 126. Thus, when the rotating element 180 is rotated, the cables 152, the plates 202 and the yokes 126 are pulled upward to release the locks 122. The actuating tabs 200 are also coupled to the plates 202. Thus, when the actuating tabs 200 are pulled upwards, the plates 202, the lower cables 204 and their respective yokes 126 are pulled upward to release the locks 122. Using the handle-mounted actuator 150 is advantageous with respect to using the actuating tabs 200 because the handle mounted actuator 150 may be operated with a single hand whereas, because the tabs 200 are located on opposite sides of the stroller 10, operating the tabs 200 requires both hands. Of course, in strollers which employ a lock on only one side, a single tab 200 may be used for actuation.

From the foregoing, persons of ordinary skill in the art will appreciate that parts and features of the above disclosed strollers and/or methods may be combined and/or excluded in many different ways. For example, the secondary handle 30 may be used with and/or without the release mechanism 150 and vice versa. Indeed, the secondary handle 30 may be advantageously used on strollers that fold and/or on strollers that do not fold.

Although example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A stroller comprising:
a wheeled frame;
a first handle; and
a second handle pivotably coupled to the first handle.

2. A stroller as defined in claim 1 wherein the second handle includes a first end pivotably coupled to the first handle and a second end pivotably coupled to the first handle.

3. A stroller as defined in claim 1 further comprising a lock for releasably securing the second handle against movement relative to the first handle.

4. A stroller as defined in claim 3 wherein the lock comprises a first member, the first member being secured longitudinally movable between a first position wherein the first member engages the second handle to prevent rotation of the second handle and a second position wherein the first member is separated from the second handle to permit rotation of the second handle.

5. A stroller as defined in claim 1 wherein the first handle comprises:
a first arm extending rearwardly from the wheeled frame;
a second arm extending rearwardly from the wheeled frame; and
a grip joining the first and second arms.

6. A stroller as defined in claim 5 wherein the second handle is pivotably coupled to the grip of the first handle.

7. A stroller as defined in claim 6 wherein the second handle is rotatable relative to the grip of the first handle.

8. A stroller as defined in claim 6 further comprising a lock for releasably securing the second handle relative to the first handle.

9. A stroller as defined in claim 8 wherein the lock comprises a first member, the first member being longitudinally movable between a first position wherein the first member engages the second handle to prevent rotation of the second handle and a second position wherein the first member is separated from the second handle to permit rotation of the second handle.

10. A stroller as defined in claim 6 wherein the second handle includes a first end pivotably coupled to the first handle and a second end pivotably coupled to the first handle.

11. A stroller as defined in claim 1 wherein the first handle is generally U-shaped.

12. A stroller as defined in claim 11 wherein the second handle is generally U-shaped.

13. A stroller as defined in claim 1 wherein each of the first and second handles has a center, and the centers of the first and second handles are aligned.

14. A stroller as defined in claim 13 wherein the centers of the first and second handles are substantially located on a central axis of the stroller.

15. A stroller as defined in claim 1 wherein the second handle extends at least one of: (a) rewardly from the first handle, (b) forwardly of the first handle, (c) above the first handle, and (d) below the first handle.

16. A stroller comprising:
a wheeled frame;
a first handle; and
a second handle having a first end pivotably coupled to the first handle and a second end pivotably coupled to the first handle.

17. A stroller comprising:
a wheeled frame;
a first handle dimensioned to be gripped with two hands; and
a second handle pivotably coupled to the first handle and dimensioned to be gripped with one hand.

18. A stroller as defined in claim 17 wherein the first handle includes a first gripping section on a first side of the second handle and a second gripping section on a second side of the second handle.

19. A stroller as defined in claim 18 wherein the second handle includes a third gripping section, the third gripping section being located between the first and second gripping sections of the first handle.

20. A stroller as defined in claim 18 wherein the second handle includes a first end pivotably coupled to the first handle and a second end pivotably coupled to the first handle, the first and second ends being coupled to the first handle between the first and second gripping sections.

21. A stroller comprising:
a wheeled frame;
a first handle having a first gripping surface;
a second handle having a second gripping surface, the second gripping surface being positionable in a range of positions relative to the first gripping surface.

22. A stroller as defined in claim 21 wherein the range of positions are located in an arc around at least a portion of the first handle.

23. A stroller as defined in claim 21 wherein the range of positions includes at least two of (a) a position above the first gripping surface, (b) a position below the first gripping surface, (c) a position in a same plane as the first gripping surface, (d) a position behind the first gripping surface, and (e) a position forward of the first gripping surface.

24. A method of operating a stroller comprising:
disengaging a lock securing a first handle in a first position relative to a second handle of the stroller;
moving the first handle of the stroller relative to the second handle of the stroller; and
re-engaging the lock to secure the first handle in a second position relative to the first position.

25. A method as defined in claim 24 wherein disengaging the lock comprises moving a first element along a longitudinal axis of the second handle.

26. A method as defined in claim 24 wherein moving the first handle comprises rotating the first handle relative to the second handle.

27. A method as defined in claim 26 wherein rotating the first handle relative to the second handle comprises rotating the first handle about a central axis of the second handle.
